(19) United States
(12) Patent Application Publication
(10) Pub. No.: US 2003/0081363 A1
(43) Pub. Date: May 1, 2003

(54) ESD protection device and method of manufacturing the device

(76) Inventors: Hirobumi Kawashima, Kawasaki-shi (JP); Naoyuki Shigyo, Yokohama-shi (JP); Seiji Yasuda, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/278,877

(22) Filed: Oct. 24, 2002

(30) Foreign Application Priority Data
Oct. 25, 2001 (JP) 2001-328060

(51) Int. Cl. H02H 9/00

(52) U.S. Cl. 361/56

(57) ABSTRACT

An ESD protection device comprising a field-effect transistor which including a source/drain diffusion layer formed in a semiconductor region, a gate insulating film formed on a channel region between the source/drain diffusion layers, and a gate electrode formed on the gate insulating film. The first silicide layer formed on a region of one portion of the source/drain diffusion layer. A diffusion layer formed in the semiconductor region of a non-forming region of the first silicide layer in the source/drain diffusion layer. A junction depth of the diffusion layer is smaller than that of the source/drain diffusion layer.

### CROSS-REFERENCE TO RELATED APPLICATIONS

This application is based upon and claims the benefit of priority from the prior Japanese Patent Application No. 2001-328060, filed Oct. 25, 2001, the entire contents of which are incorporated herein by reference.

### BACKGROUND OF THE INVENTION

1. Field of the Invention

The present invention relates to a semiconductor device and a method of manufacturing the device, particularly to an electrostatic discharge (ESD) protection device which protects an internal circuit of the semiconductor device from an excessive surge current and a method of manufacturing the device.

2. Description of the Related Art

In general, an ESD protection device is provided in a semiconductor device to protect an internal circuit from an excessive surge current discharged from a charged metal, human body, or package.

Additionally, in recent years, a salicide (self aligned silicide) process has broadly been used in the semiconductor device. The salicide process has a merit that parasitic resistance can be reduced, and is therefore an essential technique for semiconductor elements constituting an internal circuit. However, the salicide process brings an adverse influence of deterioration of resistance to destruction onto the ESD protection device.

As a countermeasure of this problem, a technique called a silicide protection process is known. This process forms only a partial region of a source/drain diffusion layer of the ESD protection device into a non-silicide region. The diffusion layer of the portion formed into the non-silicide region by this process has a resistance higher than that of the diffusion layer of a silicified portion. A voltage drop of surge voltage occurs in the non-silicide region, and this contributes to enhancement of the resistance to destruction.

FIGS. 1A to 1H show one example of a manufacturing process of the ESD protection device in which a conventional silicide protection process is used. Here, the example applied to an N-channel metal oxide semiconductor (MOS) field-effect transistor will be described.

First, as shown in FIG. 1A, a P-type well region 102 is formed in a major surface portion of an N-type silicon substrate 101. Subsequently, a gate insulating film 103 is formed on the major surface of the silicon substrate 101 on which the well region 102 is formed, and a gate electrode 104 is formed on the gate insulating film 103.

Thereafter, as shown in FIG. 1B, the gate electrode 104 is used as a mask to implant ions, and a diffusion layers (LDD regions) 105 having a low impurity density is formed to form a lightly doped drain (LDD) structure in the surface portion of the well region 102.

Moreover, as shown in FIG. 1C, a thin insulating film 106 is deposition-formed on a resultant semiconductor structure. This insulating film 106 prevents the major surface of the substrate 101 from being etched at an etch-back time for forming a side-wall spacer.

Subsequently, as shown in FIG. 1D, a thick insulating film 107 is deposition-formed on the thin insulating film 106 in order to form a side-wall spacer 108.

Thereafter, as shown in FIG. 1E, the thick insulating film 107 is etched back. Thereby, the side-wall spacer 108 is formed in a side-wall portion of the gate electrode 104.

Moreover, as shown in FIG. 1F, the surface portion of the P-type well region 102 is subjected to ion implantation for forming a source/drain diffusion layer 109 and thermal treatment for activating implanted impurity ions.

Subsequently, the insulating film such as tetra ethoxy silane (TEOS) is deposition-formed on the resultant semiconductor structure. The insulating film is etched using a photoresist mask (not shown) and leaving only a silicide protection region.

By this process, as shown in FIG. 1G, a silicide protection mask 110 is formed onto the non-silicide region on which the silicide layer is not formed.

Thereafter, when the salicide process is performed, as shown in FIG. 1H, silicide layers 111 are formed on the source/drain diffusion layer 109 and gate electrode 104 excluding a forming portion of the silicide protection mask 110 (the non-silicide region in which the silicide layer is not formed).

In this case, it is possible to separately form the silicide region (forming region of the silicide layers 111) and a non-silicide region (region in which the silicide layers 111 are not formed) 112.

However, in this manufacturing method, a process for forming the silicide protection mask 110 has to be added, and there is a disadvantage that the manufacturing process is complicated. Moreover, a sheet resistance of the portion formed into the non-silicide region 112 depends on formation conditions of the source/drain diffusion layer 109. Therefore, it is impossible to independently control only the sheet resistance of the non-silicide region 112, and the sheet resistance cannot further be increased.

To solve the problem, as a method of increasing the sheet resistance of the portion formed into the non-silicide region 112, a method of lengthening the non-silicide region 112 is known. However, when the silicide protection region is increased, an area of the ESD protection device proportionally increases. Therefore, there is a problem that cost increase is caused.

Moreover, as a solution measure of the problem that the process for forming the silicide protection mask 110 has to be added, there has been proposed a method of forming the silicide protection mask 110 at a forming time of the side-wall spacer 108 in order to decrease the number of manufacturing steps.

FIGS. 2A to 2G show an example in which the forming of the silicide protection mask is performed simultaneously with the forming of the side-wall spacer 108. In this method, as shown in FIG. 2D, when a photoresist mask 114 is formed on the thick insulating film 107, the forming of a silicide protection mask 110′ is also performed at the forming time of the side-wall spacer 108. Therefore, a step of deposition-forming a new insulating film or an etching step does not have to be added. Additionally, in this method, the portion formed as the non-silicide region 112 is subjected only to the ion implantation for LDD regions 105. Therefore, it is possible to increase the sheet resistance of the portion formed as the non-silicide region 112.

However, to increase the sheet resistance of the non-silicide region 112, another problem is generated that the sheet resistance of the LDD regions 105 becomes excessively high. Therefore, when a large current flows between the source/drain diffusion layers 109, an excessive Joule heat increases in the portions of the LDD regions 105 formed into the non-silicide regions 112. As a result, heat generation in the LDD regions 105 becomes dominant, and this is a factor for reducing the resistance to destruction.

As described above, in the conventional ESD protection device and the manufacturing method, there are disadvantages that controllability of the forming of the diffusion layer in the non-silicide region is bad and this lowers the resistance to destruction.

### BRIEF SUMMARY OF THE INVENTION

According to an aspect of the present invention, there is provided an ESD protection device comprising: a field-effect transistor including a source/drain diffusion layer formed in a semiconductor region, a gate insulating film formed on a channel region between the source/drain diffusion layers, and a gate electrode formed on the gate insulating film; a first silicide layer formed on a region of one portion of the source/drain diffusion layer; and a diffusion layer formed in the semiconductor region of a non-forming region of the first silicide layer in the source/drain diffusion layer, wherein a junction depth of the diffusion layer is smaller than that of the source/drain diffusion layer.

According to another aspect of the present invention, there is provided a method of manufacturing an ESD protection device, comprising: forming a semiconductor region in a major surface portion of a semiconductor substrate; forming a gate insulating film on the surface of the semiconductor region; forming a gate electrode on the gate insulating film; introducing an impurity into a surface portion of the semiconductor region used to the gate electrode as a mask, and forming an LDD region having a first junction depth; forming a side-wall spacer on the gate electrode; introducing the impurity into the surface portion of the semiconductor region used to the gate electrode and side-wall spacer as the masks, and forming a first diffusion layer having a second junction depth larger than the first junction depth in the surface portion of the semiconductor region; forming a mask layer on a region of one portion of the first diffusion layer; introducing the impurity into the surface portion of the semiconductor region used to the gate electrode, side-wall spacer, and mask layer as the masks, and forming a second diffusion layer having a third junction depth larger than the second junction depth and functioning as a source/drain in the surface portion of the semiconductor region; and forming a silicide layer in the surface portion of the semiconductor region exposed by a salicide process.

### BRIEF DESCRIPTION OF THE SEVERAL VIEWS OF THE DRAWING

FIGS. 1A to 1H are step sectional views showing one example of manufacturing steps of an ESD protection device using a silicide protection process in order to show a conventional ESD protection device and method of manufacturing the device;

FIGS. 2A to 2G are step sectional views showing one example of manufacturing steps of the ESD protection device in which a silicide protection mask is is formed simultaneously with a side-wall spacer, in order to show the method of manufacturing the conventional improved ESD protection device;

FIG. 3 is a circuit diagram showing one extracted portion of the ESD protection device and internal circuit in order to show the semiconductor device and manufacturing method according to a first embodiment of the present invention;

FIGS. 4A to 4H are step sectional views successively showing manufacturing steps in order to show the semiconductor device and manufacturing method according to the first embodiment of the present invention;

FIG. 5 is a characteristic diagram showing a simulation result of dependence of ESD withstand pressure on a silicide block width in the ESD protection device according to the first embodiment of the present invention;

FIGS. 6A to 6I are step sectional views successively showing manufacturing steps in order to show the ESD protection device and manufacturing method according to a second embodiment of the present invention;

FIGS. 7A to 7H are step sectional views successively showing manufacturing steps in order to show the semiconductor device and manufacturing method according to a third embodiment of the present invention; and

FIGS. 8A to 8E are step sectional views successively showing the manufacturing steps in order to show the ESD protection device and manufacturing method according to a fourth embodiment of the present invention.

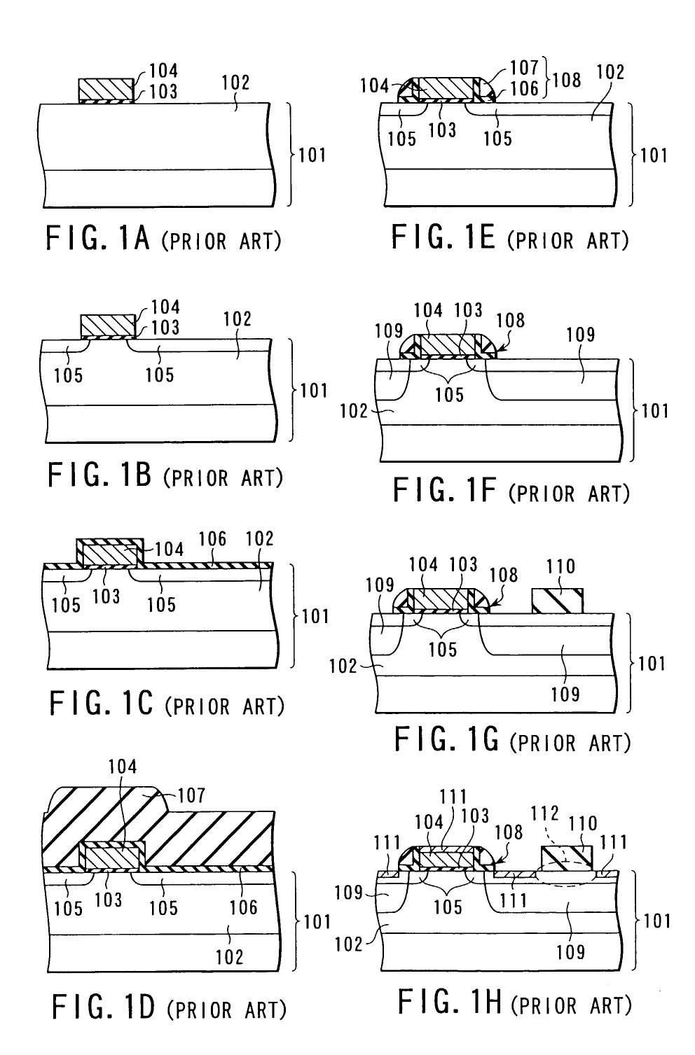

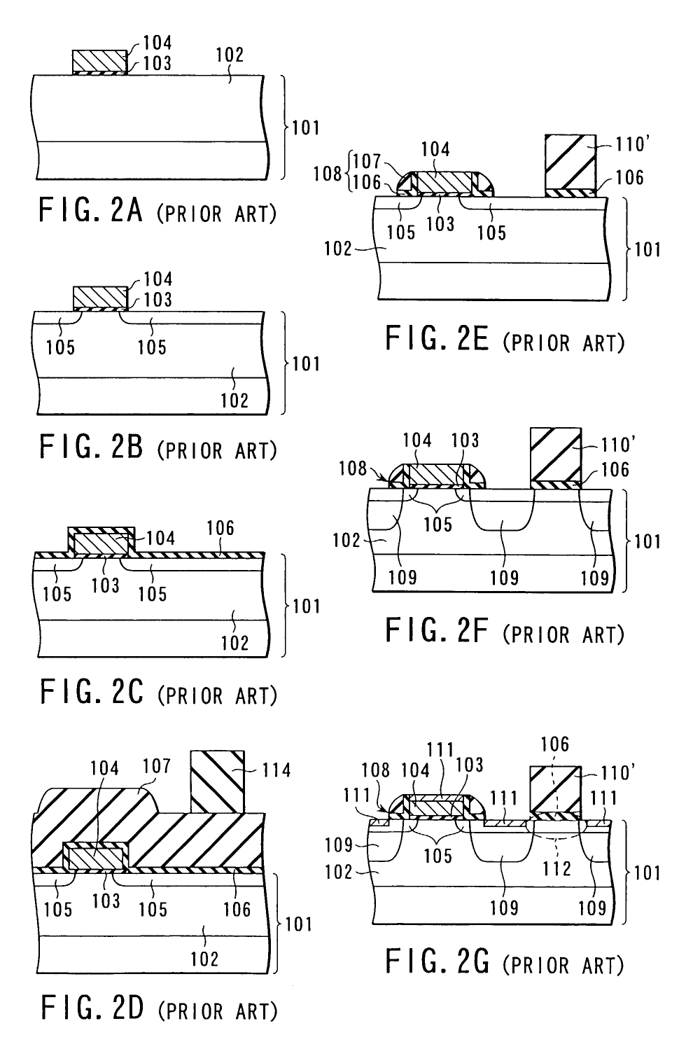

### DETAILED DESCRIPTION OF THE INVENTION

### First Embodiment

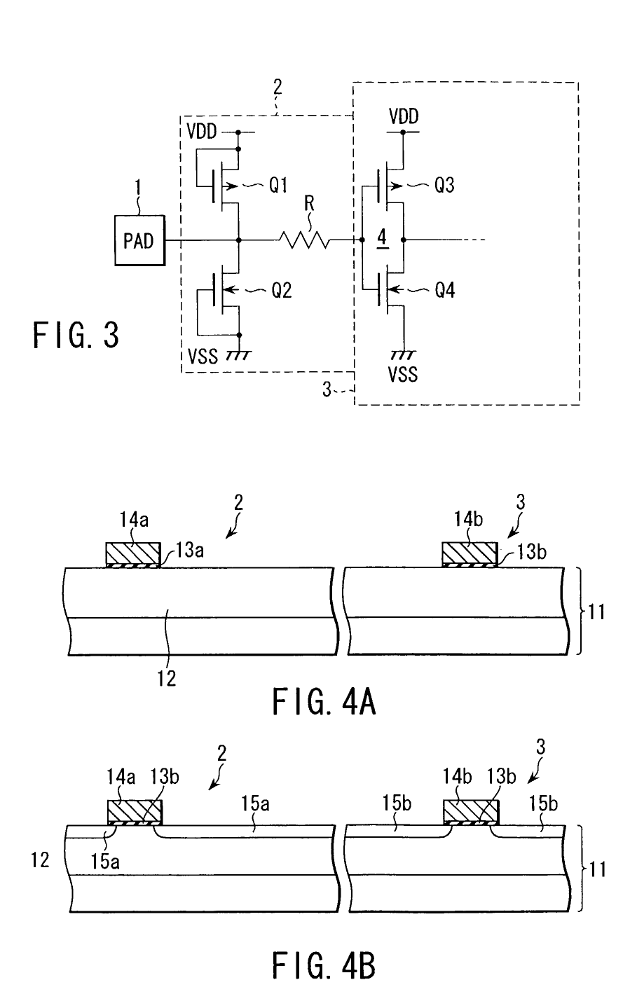

FIG. 3 shows a semiconductor device and manufacturing method according to a first embodiment of the present invention, and shows one extracted portion of an ESD protection device and internal circuit. An input pad (PAD) 1 is connected to an ESD protection device 2 including a P-channel MOS type field-effect transistor Q1, N-channel MOS type field-effect transistor Q2, and resistance R. A source and gate of the transistor Q1 are connected to a power supply VDD, and a drain thereof is connected to the input pad 1. The source and gate of the transistor Q2 are connected to a power supply (ground point) VSS, and a drain thereof is connected to the input pad 1. One end of the resistance R is connected to the input pad 1, and the other end thereof is connected to an internal circuit 3. In an input stage of the internal circuit 3, there is disposed a CMOS inverter 4 constituted of a P-channel MOS-type field-effect transistor Q3 and N-channel MOS-type field-effect transistor Q4. The input end of the CMOS inverter 4 is connected to the other end of the resistance R, and the output end thereof is connected to various circuits (not shown).

In the above-described constitution, at a usual operation time, the transistors Q1, Q2 are in an off state and a signal supplied to the input pad 1 is supplied to the input end of the CMOS inverter 4 in the internal circuit 3 via the resistance R.

Moreover, when an excessive surge voltage is applied to the input pad 1, the transistor Q1 or Q2 is turned on, and a surge current is guided to the power supply VDD or VSS. Thereby, the transistors Q3, Q4 disposed in the input stage of the internal circuit 3 are protected from gate destruction.

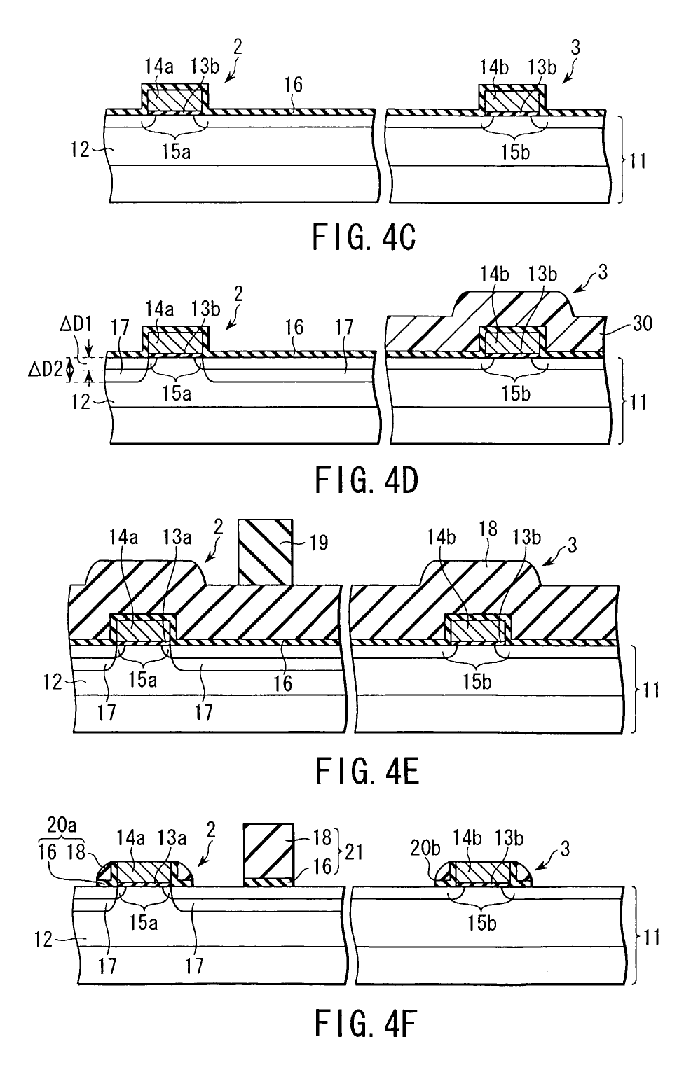

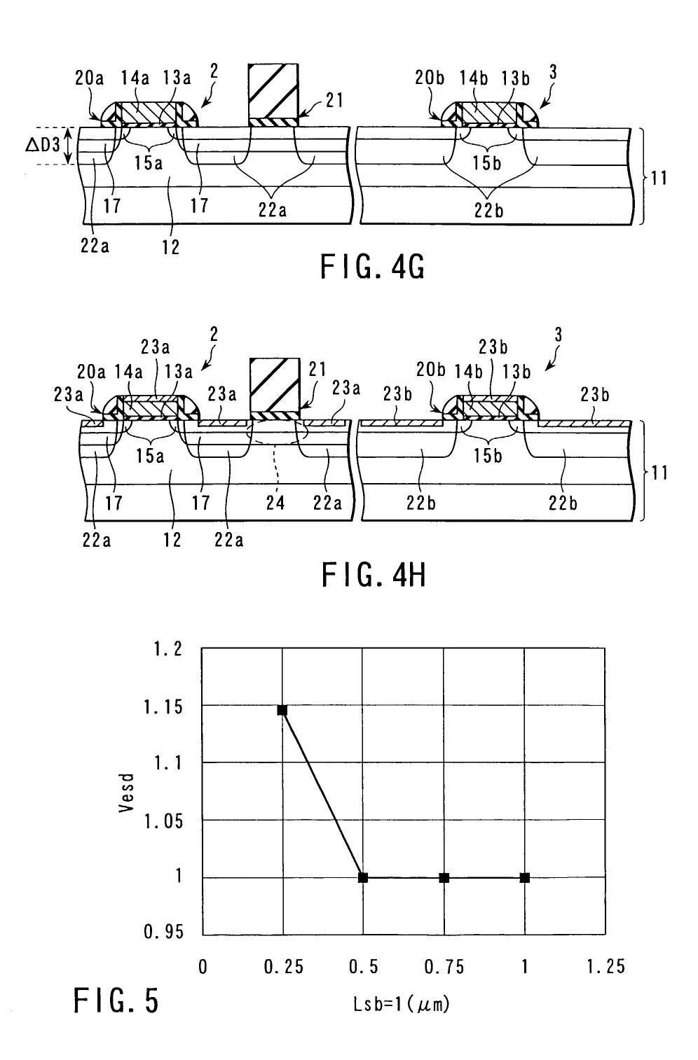

FIGS. 4A to 4H show the semiconductor device and method of manufacturing the device according to the first embodiment of the present invention, and successively show manufacturing steps. For the semiconductor device of the first embodiment, in one semiconductor chip, the ESD protection device formed by a MOS-type field-effect transistor having an LDD structure, and a MOS-type field-effect transistor having the LDD structure as a semiconductor device constituting the internal circuit are mounted in a mixed manner. Here, to simplify the description, the manufacturing steps of the N-channel MOS-type field-effect transistors Q2 and Q4 in the circuit shown in FIG. 3 will be noted to describe the manufacturing steps. The P-channel MOS-type field-effect transistors Q1 and Q3 can similarly be formed by changing a conductive type of each portion.

First, as shown in FIG. 4A, a P-type well region (semiconductor region) 12 is formed in a major surface portion of an N-type silicon substrate (semiconductor substrate) 11. Moreover, on the major surface of the silicon substrate 11 corresponding to a forming region of the ESD protection device 2 (first device forming region) and a forming region 3 (second device forming region) of the semiconductor device constituting the internal circuit 3, an insulating film having a thickness of about 6 nm is formed. Thereafter, after deposition-forming a polysilicon layer on the insulating film, the layer is etched and patterned, so that gate insulating films 13a, 13b (first and second gate insulating films) and gate electrodes (first and second gate electrodes) 14a, 14b are formed.

Subsequently, as shown in FIG. 4B, in the surface portions of the P-type well region 12 corresponding to the forming region of the ESD protection device 2 and the forming region 3 of the semiconductor device, ion implantation of arsenic is performed, thermal treatment is performed to activate implanted impurity ions, and N-type diffusion layers (LDD regions) 15a, 15b having a low impurity density are formed to form an LDD structure. At this time, an ion acceleration energy is in a range of about 5 to 10 keV, and a dosage is about 5×10¹⁴ cm⁻².

Subsequently, as shown in FIG. 4C, a thin insulating film 16 having a thickness of about 30 nm is deposition-formed on a resultant semiconductor structure. This insulating film 16 prevents the major surface of the substrate 11 from being etched at an etch-back time for forming a side-wall spacer.

Subsequently, the forming region 3 of the semiconductor device is covered with a mask layer 30, and as shown in FIG. 4D, only the forming region of the ESD protection device 2 is subjected to the ion implantation of arsenic. Thereby, an N-type diffusion layer 17 of a portion later forming the non-silicide region (silicide protection region) is formed. The acceleration energy and dosage of ions at this time are set to values such that a junction depth ΔD2 of the N-type diffusion layer 17 is larger than a junction depth ΔD1 of the diffusion layers 15a, 15b, and is smaller than a junction depth ΔD3 of a source/drain diffusion layer described later. The acceleration energy of the ions satisfying this condition is in a range of about 20 to 30 keV, and the dosage is about 20×10¹⁵ cm⁻².

Subsequently, to form a side-wall spacer, as shown in FIG. 4E, a thick insulating film 18 is deposition-formed on the thin insulating film 16. It is to be noted that the type of the thick insulating film 18 is different from that of the thin insulating film 16. For example, when the thin insulating film 16 is formed of SiN, different materials such as a TEOS-0₃-based plasma CVD oxide film are used in the thick insulating film 18.

Subsequently, a photoresist mask 19 is formed in a portion forming the non-silicide region in the forming region of the ESD protection device, and the etching (etch-back) of the insulating films 16, 18 is performed. Thereby, as shown in FIG. 4F, simultaneously with the forming of side-wall spacers 20a, 20b, a silicide protection mask 21 (insulating films 16, 18) is formed.

Subsequently, as shown in FIG. 4G, the gate electrodes 14a, 14b, side-wall spacers 20a, 20b, and silicide protection mask 21 are used as masks to implant the ions of arsenic into the major surface portion (surface portion of the P-type well region 12) of the substrate 11. Moreover, when the thermal treatment is performed to activate the implanted impurity ions, source/drain diffusion layers 22a, 22b having the junction depth ΔD3 are formed. At this time the acceleration energy of ions is in a range of about 50 to 60 keV, and the dosage is about 5×10¹⁵ cm⁻².

Thereafter, a salicide process is performed. That is, a metal layer of titanium or nickel is deposition-formed and thermally treated. Thereby, as shown in FIG. 4H, the surfaces of the gate electrodes 14a, 14b and source/drain diffusion layers 22a, 22b are silicified. As a result, silicide layers 23a, 23b are formed on the gate electrodes 14a, 14b and source/drain diffusion layers 22a, 22b.

At this time, silicification does not occur in a non-silicide region 24 in which the silicide protection mask 21 is formed. Therefore, in the source/drain diffusion layers 22a, 22b, the silicide region (the forming region of the silicide layer 23a) and non-silicide region 24 are separately formed.

In this manner, the semiconductor device is formed in which the N-channel MOS-type field-effect transistors Q2 and Q4 constituting the ESD protection device 2 and internal circuit 3 are mounted in the single silicon substrate 11 in the mixed manner.

As described above, since the independently controllable N-type diffusion layer 17 is formed in the non-silicide region 24, the acceleration energy and dosage of the ions in forming the N-type diffusion layer 17 can be adjusted to freely set the sheet resistance. Additionally, the forming of the N-type diffusion layer 17 can easily be realized only by adding an ion implantation step.

When the forming of the N-type diffusion layer 17 in the portion forming the non-silicide region 24 can independently be controlled in this manner, it is possible to control the voltage drop of the surge voltage in the non-silicide region 24, and the resistance to destruction can be enhanced.

It is to be noted that with an extremely small junction depth ΔD2 of the N-type diffusion layer 17 of the portion forming the non-silicide region 24, the sheet resistance increases, and the resistance to destruction drops. In this case, when the non-silicide region 24 is shortened and the sheet resistance is lowered, ESD withstand pressure can be enhanced.

FIG. 5 shows a simulation result of dependence of the ESD withstand pressure on a silicide block width (length of the non-silicide region 24) in the FSD protection device according to the first embodiment of the present invention. The abscissa in the drawing indicates a length Lsb of the non-silicide region, and the ordinate in the drawing indicates a relative value Vesd of the withstand pressure at a time when the withstand pressure at a time of Lsb=1 μm is assumed as 1.

As clearly seen from FIG. 5, when the length of the non-silicide region 24 is set to be shorter than 0.5 μm, the ESD withstand pressure is enhanced. Moreover, when the length of the non-silicide region 24 is reduced, the miniaturization of the area of the ESD protection device is realized. As a result, it is effective for the enhancement of the ESD withstand pressure to set the silicide block width to be shorter than 0.5 μm.

It is to be noted that in the first embodiment the N-channel MOS-type field-effect transistor formed on the N-type silicon substrate has been described, but the transistor may of course be formed on the P-type silicon substrate.

### Second Embodiment

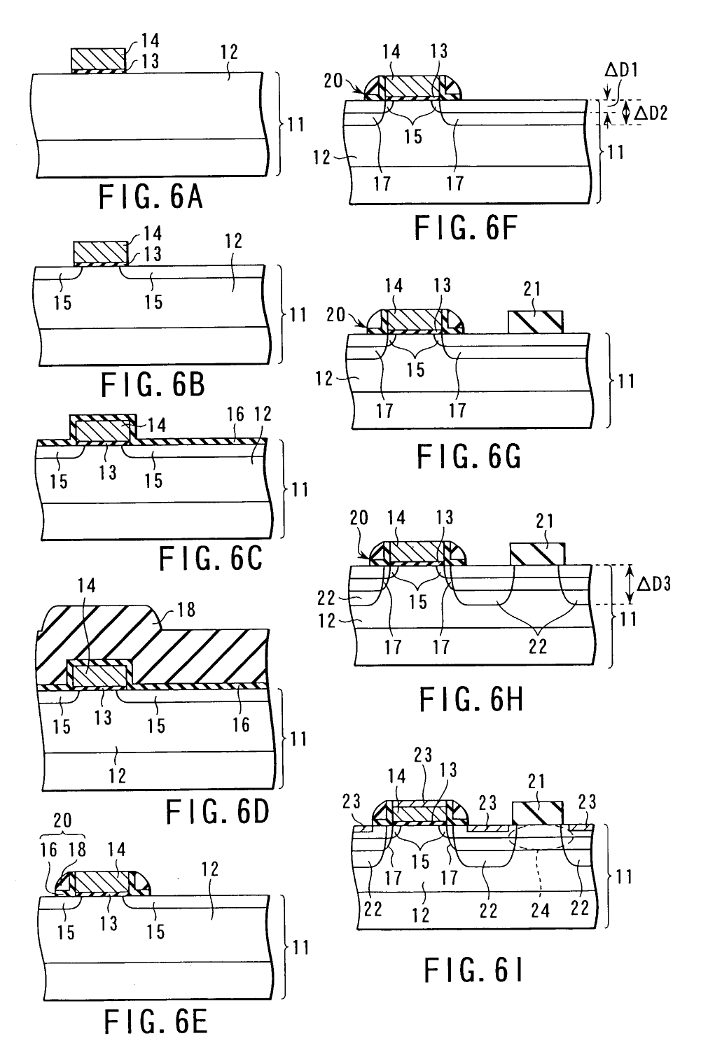

FIGS. 6A to 6I show the manufacturing steps of the ESD protection device according to a second embodiment of the present invention. Here, to simplify the description, the present invention applied to the N-channel MOS-type field-effect transistor Q2 formed using the above-described silicide protection process (see FIGS. 4A to 4H) will be described as an example. However, the P-channel MOS-type field-effect transistor Q1 can also similarly be formed by changing the conductive type of each portion.

First, as shown in FIG. 6A, the P-type well region (semiconductor region) 12 is formed in the major surface portion of the N-type silicon substrate (semiconductor substrate) 11. Subsequently, the insulating film having a thickness of about 6 nm is formed on the major surface of the silicon substrate 11 in which the P-type well region 12 is formed. Thereafter, the polysilicon layer is deposition-formed on the insulating film, etched, and patterned to form the gate electrode 14 and gate insulating film 13.

Subsequently, as shown in FIG. 6B, the gate electrode 14 is used as the mask to implant the ions of arsenic in the surface portion of the P-type well region 12. Thereafter, the thermal treatment is performed to activate the implanted impurity ions, and the N-type diffusion layers (LDD regions) 15 having the low impurity density are formed to form the LDD structure. The acceleration energy of ions at this time is in a range of about 5 to 10 keV, and the dosage is about 5×10¹⁴ cm⁻².

Subsequently, as shown in FIG. 6C, the thin insulating film 16 having a thickness of about 30 nm is deposition-formed on the resultant semiconductor structure. This insulating film 16 prevents the major surface of the substrate 11 from being etched at an etch-back time for forming the side-wall spacer.

Subsequently, to form the side-wall spacer, as shown in FIG. 6D, the thick insulating film 18 is deposition-formed on the thin insulating film 16. It is to be noted that the type of the thick insulating film 18 is different from that of the thin insulating film 16. For example, when the thin insulating film 16 is formed of SiN, the different materials such as the TEOS-O₃-based plasma CVD oxide film are used in the thick insulating film 18.

Next, the etching (etch-back) of the insulating films 16, 18 are performed. Thereby, the side-wall spacer 20 is formed as shown in FIG. 6E.

Subsequently, as shown in FIG. 6F, the gate electrode 14 and side-wall spacer 20 are used as the mask to implant the ions of arsenic into the major surface portion of the substrate 11. Thereby, the N-type diffusion layer 17 of the portion later forming the non-silicide region (silicide protection region) is formed. The acceleration energy and dosage of the ions at this time are set to values such that the junction depth ΔD2 of the N-type diffusion layer 17 is larger than the junction depth ΔD1 of the LDD regions 15, and is smaller than the junction depth ΔD3 of the source/drain diffusion layer described later. The acceleration energy of the ions satisfying this condition is in a range of about 20 to 30 keV, and the dosage is about 20×10¹⁵ cm⁻².

Subsequently, after the insulating films such as TEOS are deposition-formed on the resultant semiconductor structure, the photoresist mask is used to etch the film, so that the insulating film remains only in the silicide protection region. In this manner, as shown in FIG. 6G, the silicide protection mask 21 is formed in the portion which forms the non-silicide region.

Next, as shown in FIG. 6H, the gate electrode 14, side-wall spacer 20, and silicide protection mask 21 are used as the masks to implant the ions of arsenic in the surface portion of the P-type well region 12. Subsequently, the thermal treatment is performed to activate the implanted impurity ions, so that the source/drain diffusion layers 22 having the junction depth ΔD3 are formed. The acceleration energy of ions at this time is in a range of about 50 to 60 keV, and the dosage is about 5×10¹⁵ cm⁻².

Thereafter, the salicide process is performed. That is, the metal layer of titanium or nickel is deposition-formed and thermally treated. Thereby, as shown in FIG. 6I, the respective surfaces of the gate electrodes 14 and source/drain diffusion layers 22 are silicified. In this manner, the silicide layers 23 are formed on the gate electrodes 14 and source/drain diffusion layers 22.

At this time, the silicification does not occur in the non-silicide region 24 in which the silicide protection mask 21 is formed. As a result, in the source/drain diffusion layers 22, the silicide region (the forming region of the silicide layer 23) and non-silicide region (the region in which the silicide layer 23 is not formed) 24 are separately formed.

As described above, even in the ESD protection device using the silicide protection process, it is possible to independently control the forming of the N-type diffusion layer 17 in the non-silicide region 24. Moreover, when the acceleration energy and dosage of the ions in forming the N-type diffusion layer 17 are controlled, the sheet resistance can freely be set.

It is to be noted that in the second embodiment the N-channel MOS-type field-effect transistor formed on the N-type silicon substrate has been described, but the transistor may be formed on the P-type silicon substrate.

### Third Embodiment

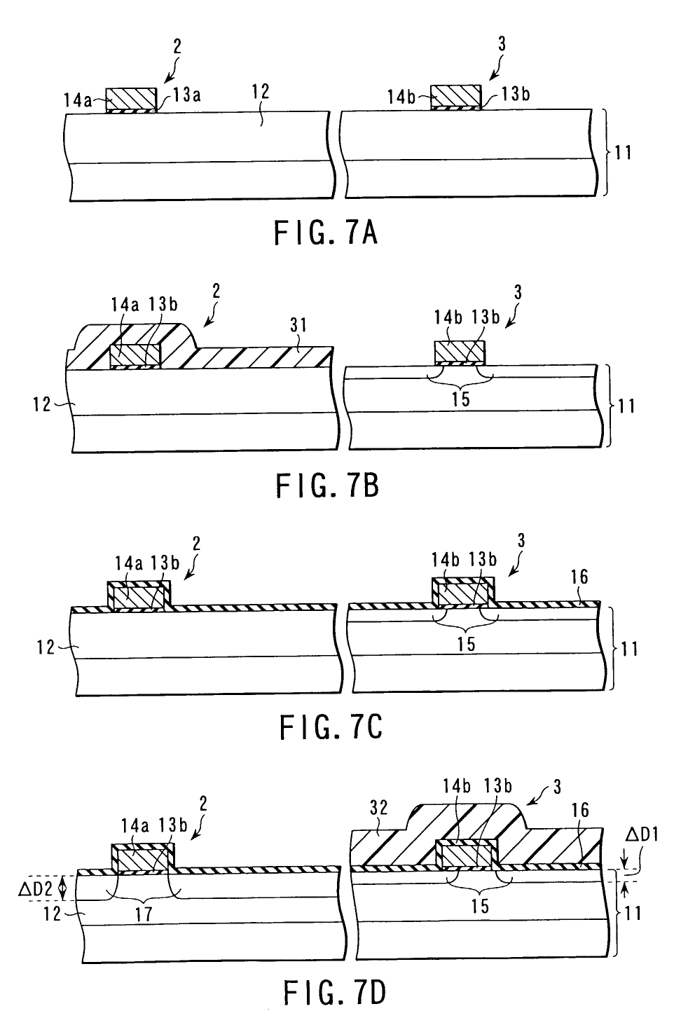

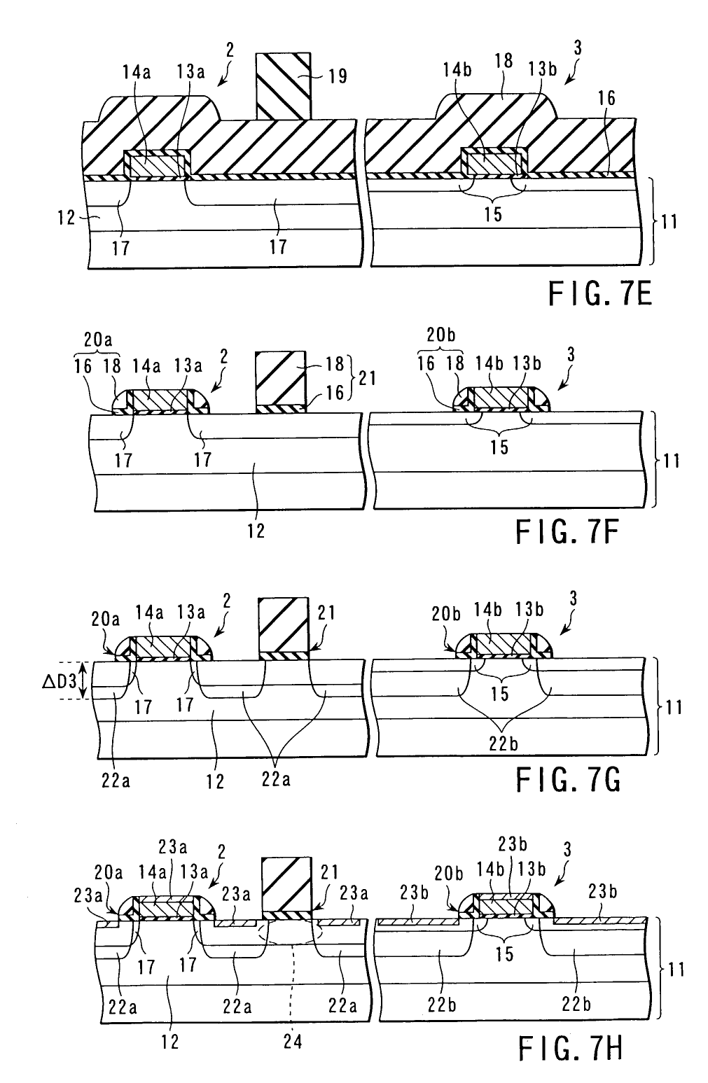

FIGS. 7A to 7H successively show the manufacturing steps of the semiconductor device according to a third embodiment of the present invention. For the semiconductor device of the third embodiment, in one semiconductor chip, the ESD protection device formed by the MOS-type field-effect transistor which does not include the LDD structure, and the MOS-type field-effect transistor having the LDD structure as the semiconductor device constituting the internal circuit are mounted in a mixed manner. Here, to simplify the description, the manufacturing steps of the N-channel MOS-type field-effect transistors Q2 and Q4 in the circuit shown in FIG. 3 will be noted to describe the embodiment. The P-channel MOS-type field-effect transistors Q1 and Q3 can similarly be formed by changing the conductive type of each portion.

First, as shown in FIG. 7A, the P-type well region (semiconductor region) 12 is formed in the major surface portion of the N-type silicon substrate (semiconductor substrate) 11. Subsequently, the insulating film having a thickness of about 6 nm is formed on the major surface of the silicon substrate 11 corresponding to the forming region (first device forming region) of the ESD protection device 2 and the forming region 3 (second device forming region) of the semiconductor device constituting the internal circuit 3. Thereafter, the polysilicon layer is deposition-formed on the insulating film, etched, and patterned to form the gate insulating films 13a, 13b (first, second gate insulating films) and gate electrodes (first, second gate electrodes) 14a, 14b.

Subsequently, as shown in FIG. 7B, the ions of arsenic are implanted in the surface portion of the P-type well region 12 in a state in which the forming region of the internal circuit 3 is covered with a mask layer 31. Subsequently, the thermal treatment is performed to activate the implanted impurity ions, and the N-type diffusion layers (LDD regions) 15 having the low impurity density are formed to form the LDD structure of the transistor constituting the internal circuit 3. The acceleration energy of ions at this time is in a range of about 5 to 10 keV, and the dosage is about 5×10¹⁴ cm⁻².

Subsequently, as shown in FIG. 7C, the thin insulating film 16 having a thickness of about 30 nm is deposition-formed on the resultant semiconductor structure. This insulating film 16 prevents the major surface of the substrate 11 from being etched at the etch-back time for forming the side-wall spacer.

Next, as shown in FIG. 7D, in the state in which the forming region 3 of the semiconductor device is covered with a mask layer 32, the ions of arsenic are implanted only in the forming region of the ESD protection device 2. Thereby, the N-type diffusion layer 17 of the portion later forming the non-silicide region (silicide protection region) is formed. The acceleration energy and dosage of the ions at this time are set to values such that the junction depth ΔD2 of the N-type diffusion layer 17 is larger than the junction depth ΔD1 of the LDD regions 15, and is smaller than the junction depth ΔD3 of the source/drain diffusion layer described later. For example, the acceleration energy of the ions is in a range of about 20 to 30 keV, and the dosage is about 20×10¹⁵ cm⁻².

Subsequently, to form the side-wall spacer, as shown in FIG. 7E, the thick insulating film 18 is deposition-formed on the thin insulating film 16. It is to be noted that the type of the thick insulating film 18 is different from that of the thin insulating film 16. For example, when the thin insulating film 16 is formed of SiN, the different materials such as the TEOS-O₃-based plasma CVD oxide film are used in the thick insulating film 18.

Next, the photoresist mask 19 is formed in the portion forming the non-silicide region in the forming region of the ESD protection device 2, and the etching (etch-back) of the insulating films 16, 18 is performed. Thereby, as shown in FIG. 7F, simultaneously with the forming of the side-wall spacers 20a, 20b, the silicide protection mask 21 (insulating films 16, 18) is formed.

Subsequently, as shown in FIG. 7G, the ions of arsenic are implanted in the major surface portion of the substrate 11, the thermal treatment is performed to activate the implanted impurity ions, and thereby the source/drain diffusion layers 22a, 22b having the junction depth ΔD3 are formed. The acceleration energy of ions at this time is in a range of about 50 to 60 keV, and the dosage is about 5×10¹⁵ cm⁻².

Thereafter, the salicide process is executed. That is, the metal layer of titanium or nickel is deposition-formed and thermally treated. Thereby, as shown in FIG. 7H, the respective surfaces of the gate electrodes 14a, 14b and source/drain diffusion layers 22a, 22b are silicified. In this manner, the silicide layers 23a, 23b are formed on the gate electrodes 14a, 14b and source/drain diffusion layers 22a, 22b.

At this time, the silicification does not occur in the non-silicide region 24 in which the silicide protection mask 21 is formed. As a result, in the source/drain diffusion layers 22a, 22b, the silicide region (the forming region of the silicide layer 23a) and non-silicide region 24 are separately formed.

In this manner, the semiconductor device is formed in which the N-channel MOS-type field-effect transistor Q2 which does not include the LDD regions constituting the ESD protection device 2, and the N-channel MOS-type field-effect transistor Q4 including the LDD regions 15 constituting the internal circuit 3 are mounted in the single silicon substrate 11 in the mixed manner.

Even in the device according to the third embodiment, similarly as the first embodiment, in the non-silicide region 24, the N-type diffusion layer 17 is formed in which the junction depth and impurity density can independently be controlled, and therefore the sheet resistance can freely be set by the N-type diffusion layer 17.

It is to be noted that in the third embodiment, the N-channel MOS-type field-effect transistor formed on the N-type silicon substrate has been described, but the transistor may also be formed on the P-type silicon substrate.

### Fourth Embodiment

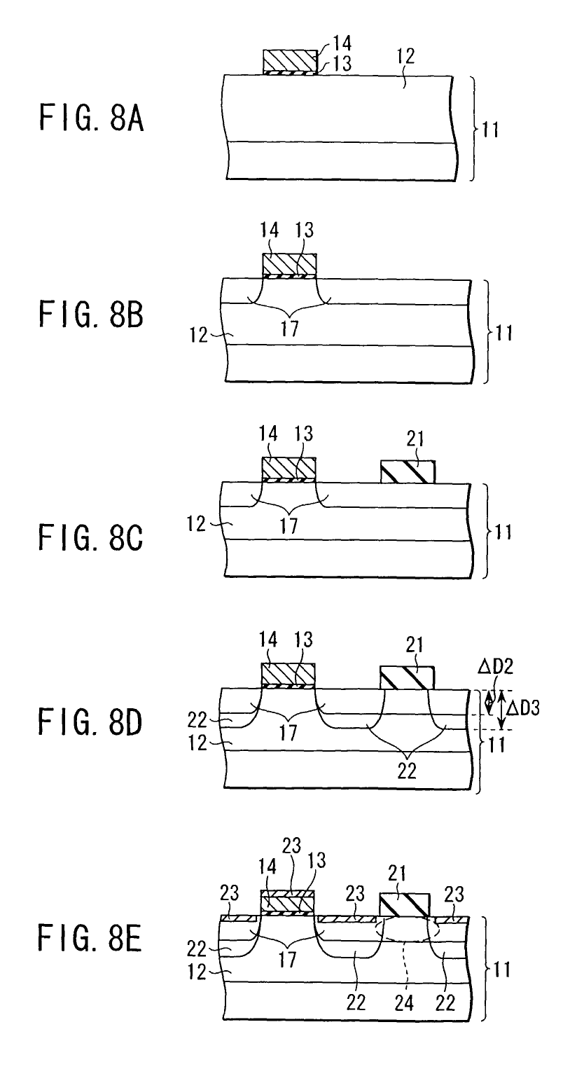

FIGS. 8A to 8E successively show the manufacturing steps of the ESD protection device according to a fourth embodiment of the present invention. Here, an example of the application of the method of manufacturing the ESD protection device according to the second embodiment to the N-channel MOS-type field-effect transistor not including the LDD regions will be described.

First, as shown in FIG. 8A, the P-type well region (semiconductor region) 12 is formed in the major surface region portion of the N-type silicon substrate (semiconductor substrate) 11. Moreover, on the major surface of the silicon substrate 11 in which the P-type well region 12 is formed, the insulating film having a thickness of about 6 nm is formed. Thereafter, after deposition-forming the polysilicon layer on the insulating film, the layer is etched and patterned, so that the gate insulating film 13 and gate electrode 14 are formed.

Next, as shown in FIG. 8B, the gate electrode 14 is used as the mask to implant the ions of arsenic in the surface portion of the well region. Thereby, the N-type diffusion layer 17 of the portion later forming the non-silicide region (silicide protection region) is formed. The acceleration energy and dosage of the ions at this time are set to the values such that the junction depth ΔD2 of the N-type diffusion layer 17 is smaller than the junction depth ΔD3 of the source/drain diffusion layer described later. For example, the acceleration energy of the ions is in a range of about 20 to 30 keV, and the dosage is about 20×10¹⁵ cm⁻².

Subsequently, after the insulating films such as TEOS are deposition-formed on the resultant semiconductor structure, the photoresist mask is used to etch the film, so that the insulating film remains only in the silicide protection region. In this manner, as shown in FIG. 8C, the silicide protection mask 21 is formed in the portion which forms the non-silicide region.

Next, as shown in FIG. 8D, the ions of arsenic are implanted in the major surface portion of the substrate 11, and the thermal treatment is performed to activate the implanted impurity ions, so that the source/drain diffusion layer (second diffusion layer having the second junction depth) 22 having the junction depth ΔD3 is formed. The acceleration energy of ions at this time is in a range of about 50 to 60 keV, and the dosage is about 5×10¹⁵ cm⁻².

Thereafter, the salicide process is performed. That is, the metal layer of titanium or nickel is deposition-formed and thermally treated. Thereby, as shown in FIG. 8E, the respective surfaces of the gate electrode 14 and source/drain diffusion layer 22 are silicified. In this manner, the silicide layers 23 are formed on the gate electrodes 14 and source/drain diffusion layers 22.

At this time, the silicification does not occur in the non-silicide region 24 in which the silicide protection mask 21 is formed. As a result, in the source/drain diffusion layers 22, the silicide region (the forming region of the silicide layer 23) and non-silicide region 24 are separately formed.

As described above, even in the MOS-type field-effect transistor which does not include the LDD regions, it is possible to independently control the forming of the N-type diffusion layer 17 in the non-silicide region 24. Moreover, the N-type diffusion layer 17 in which the junction depth and impurity density can independently be controlled is formed, and the sheet resistance can therefore freely be set.

It is to be noted that in the fourth embodiment, the N-channel MOS-type field-effect transistor formed on the N-type silicon substrate has been described, but the transistor may also be formed on the P-type silicon substrate.

Moreover, in the first to fourth embodiments, the example in which the LDD regions are formed on both the source and drain diffusion layers has been described. However, when more integration properties are required, the LDD region may also be disposed only on one diffusion layer side, for example, in contact with the drain diffusion layer.

As described above, according to one aspect of the invention, there can be provided a semiconductor device and manufacturing method in which the voltage drop in the non-silicide region can be controlled and the resistance to destruction can be enhanced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An ESD protection device comprising:
a field-effect transistor including a source/drain diffusion layer formed in a semiconductor region, a gate insulating film formed on a channel region between the source/drain diffusion layers, and a gate electrode formed on the gate insulating film;
a first silicide layer formed on a region of one portion of the source/drain diffusion layer; and
a diffusion layer formed in the semiconductor region of a non-forming region of the first silicide layer in the source/drain diffusion layer, wherein a junction depth of the diffusion layer is smaller than that of the source/drain diffusion layer.

2. The ESD protection device according to claim 1, further comprising an LDD region which is disposed in contact with at least one of the source/drain diffusion layers in the channel region between the source/drain diffusion layers and whose junction depth is smaller than that of the source/drain diffusion layer and diffusion layer.

3. The ESD protection device according to claim 1, wherein the semiconductor region is a well region formed in the major surface portion of the silicon substrate.

4. The ESD protection device according to claim 1, further comprising a second silicide layer formed on the gate electrode.

5. The ESD protection device according to claim 1, wherein a length of the non-forming region of the first silicide layer is shorter than 0.5 μm.

6. An ESD protection device comprising:
a semiconductor substrate;
a well region provided in the major surface portion of the semiconductor substrate;
a gate insulating film formed on the surface of the well region;
a gate electrode provided on the gate insulating film;
first and second diffusion layers which are provided in a surface portion of the well region via the gate electrode in a first junction depth and which function as a source/drain;
a first silicide layer provided on a region of one portion of the first diffusion layer;
a second silicide layer provided on the second diffusion layer; and
a third diffusion layer provided in the surface portion of the well region corresponding to a non-forming region of the first silicide layer in a second junction depth smaller than the first junction depth.

7. The ESD protection device according to claim 6, further comprising an LDD region which is provided in contact with at least one of the first and second diffusion layers in the surface portion of the well region and which has a third junction depth smaller than the second junction depth.

8. The ESD protection device according to claim 6, further comprising a third silicide layer formed on the gate electrode.

9. The ESD protection device according to claim 6, wherein a length of the non-forming region of the silicide layer is shorter than 0.5 μm.

10. A semiconductor device comprising:
a first field-effect transistor which is provided in a semiconductor substrate and which constitutes at least one portion of an internal circuit and includes an LDD region; and
a second field-effect transistor which is provided in the semiconductor substrate and which constitutes at least one portion of an ESD protection device for protecting the internal circuit, the second field-effect transistor including a source/drain diffusion layer, channel region between the source/drain diffusion layers, gate insulating film, gate electrode, a first silicide layer formed on a region of one portion of the source/drain diffusion layer in the field-effect transistor, and diffusion layer formed in the semiconductor substrate in a non-forming region of the first silicide layer, a junction depth of the diffusion layer being smaller than that of the source/drain diffusion layer and larger than that of the LDD regions of the first field-effect transistor.

11. The semiconductor device according to claim 10, wherein the second field-effect transistor further includes the LDD region, and the junction depth of the LDD region is smaller than that of the diffusion layer.

12. The semiconductor device according to claim 10, wherein the semiconductor region is a well region formed in the major surface portion of the silicon substrate.

13. The semiconductor device according to claim 10, further comprising a second silicide layer formed on the gate electrode of the second field-effect transistor.

14. The semiconductor device according to claim 10, further comprising; a third silicide layer formed on the source/drain diffusion layer of the first field-effect transistor; and a fourth silicide layer formed on the gate electrode of the first field-effect transistor.

15. The semiconductor device according to claim 10, wherein a length of the non-forming region of the silicide layer is shorter than 0.5 μm.

16. A method of manufacturing an ESD protection device, comprising:
forming a semiconductor region in a major surface portion of a semiconductor substrate;
forming a gate insulating film on the surface of the semiconductor region;
forming a gate electrode on the gate insulating film;
introducing an impurity into a surface portion of the semiconductor region used to the gate electrode as a mask, and forming an LDD region having a first junction depth;
forming a side-wall spacer on the gate electrode;
introducing the impurity into the surface portion of the semiconductor region used to the gate electrode and side-wall spacer as the masks, and forming a first diffusion layer having a second junction depth larger than the first junction depth in the surface portion of the semiconductor region;
forming a mask layer on a region of one portion of the first diffusion layer;
introducing the impurity into the surface portion of the semiconductor region used to the gate electrode, side-wall spacer, and mask layer as the masks, and forming a second diffusion layer having a third junction depth larger than the second junction depth and functioning as a source/drain in the surface portion of the semiconductor region; and
forming a silicide layer in the surface portion of the semiconductor region exposed by a salicide process.

17. The method of manufacturing the ESD protection device according to claim 16, wherein the salicide process includes: forming the silicide layer further on the gate electrode.

18. A method of manufacturing an ESD protection device, comprising:
forming a semiconductor region in a major surface portion of a semiconductor substrate;
forming a gate insulating film on the surface of the semiconductor region;
forming a gate electrode on the gate insulating film;
introducing an impurity into a surface portion of the semiconductor region used to the gate electrode as a mask, and forming a first diffusion layer having a first junction depth in the surface portion of the semiconductor region;
forming a mask layer on a region of one portion of the first diffusion layer;
introducing the impurity into the surface portion of the semiconductor region used to the gate electrode and mask layer as the masks, and forming a second diffusion layer having a second junction depth larger than the first junction depth and functioning as a source/drain in the surface portion of the semiconductor region; and
forming a silicide layer in the surface portion of the semiconductor region exposed by a salicide process.

19. The method of manufacturing the ESD protection device according to claim 18, wherein the salicide process includes: forming the silicide layer further on the gate electrode.

20. A method of manufacturing a semiconductor device, comprising:
forming a semiconductor region in a major surface portion of a semiconductor substrate;
forming first and second gate insulating films on the surface of the semiconductor region corresponding to first and second device forming regions;
forming first and second gate electrodes on the first and second gate insulating films;
introducing an impurity into a surface portion of the semiconductor region used to the first and second gate electrodes as masks, and forming LDD regions having a first junction depth;
forming a first insulating film on the semiconductor region and first and second gate electrodes;
introducing the impurity into the surface portion of the semiconductor region used to the first and second gate electrodes as the masks, and forming a first diffusion layer having a second junction depth larger than the first junction depth;
forming a second insulating film on the first insulating film;
forming a mask layer on the second insulating film on one portion of the LDD region in the first device forming region;
etching back the second insulating film via the mask layer, forming first and second side-wall spacers in the first and second gate electrodes, and leaving one portion of the second insulating film under the mask layer;
introducing the impurity into the first device forming region used to the first gate electrode, the first side-wall spacer, and the left portion of the second insulating film as the masks, and forming a second diffusion layer having a third junction depth larger than the second junction depth and functioning as a source/drain in the surface portion of the first device forming region; and
forming a silicide layer in the surface portion of the semiconductor region exposed by a salicide process.

21. The method of manufacturing the semiconductor device according to claim 20, wherein the salicide process includes forming the silicide layer further on the gate electrode.

22. A method of manufacturing a semiconductor device, comprising:
forming a semiconductor region in a major surface portion of a semiconductor substrate;
forming first and second gate insulating films on the surface of the semiconductor region corresponding to first and second device forming regions;
forming first and second gate electrodes on the first and second gate insulating films;
introducing an impurity into a surface portion of the semiconductor region in the second device forming region used to the second gate electrode as a mask, and forming an LDD region having a first junction depth;
forming a first insulating film on the semiconductor region and first and second gate electrodes;
introducing the impurity into the surface portion of the semiconductor region in the first device forming region used to the first gate electrode as the mask, and forming a first diffusion layer having a second junction depth larger than the first junction depth;
forming a second insulating film on the first insulating film;
forming a mask layer on the second insulating film on one portion of the LDD region in the first device forming region;
etching back the second insulating film via the mask layer, forming first and second side-wall spacers in the first and second gate electrodes, and leaving one portion of the second insulating film under the mask layer;
introducing the impurity into the first device forming region used to the first gate electrode, the first side-wall spacer, and the left portion of the second insulating film as the masks, and forming a second diffusion layer having a third junction depth larger than the second junction depth and functioning as a source/drain in the surface portion of the first device forming region; and
forming a silicide layer in the surface portion of the semiconductor region exposed by a salicide process.

23. The method of manufacturing the semiconductor device according to claim 22, wherein the salicide process includes forming the silicide layer further on the gate electrode.
